(19) United States
(12) Patent Application Publication
(10) Pub. No.: US 2018/0158560 A1
(43) Pub. Date: Jun. 7, 2018

(54) Nuclear radiation thermoelectron engine

(71) Applicant: Joshua Ryan Smith, Washington, DC (US)

(72) Inventor: Joshua Ryan Smith, Washington, DC (US)

(21) Appl. No.: 15/368,603

(22) Filed: Dec. 3, 2016

(51) Int. Cl. G21H 1/10

(52) U.S. Cl. CPC G21H 1/106

(57) ABSTRACT

Techniques are provided for the absorption of energy carried by nuclear radiation by an emitter electrode and converting the energy to useful electrical work. An emitter electrode is provided which absorbs energy from nuclear radiation and emits a thermoelectron current, configured such that parasitic energy loss via direct thermal transport and thermal photon emission is minimized. A thermoelectron energy converter is provided which includes an emitter electrode, a nuclear source in the vicinity of the emitter electrode, a collector electrode, an enclosure, and electrical leads. Nuclear events within the nuclear source causes electron emission from the emitter electrode. The electrons emitted from the emitter electrode travel to the collector electrode and can be driven through an external circuit, outputting electrical power.

### CROSS-REFERENCE TO RELATED APPLICATIONS

This application claims priority from U.S. Provisional Application No. 62/262,577 filed on Dec. 3, 2015, the entirety of which is incorporated by reference herein.

### TECHNICAL FIELD

The disclosed subject matter relates generally to direct energy conversion devices and methods of making the same, and more specifically to thermoelectron engines and vacuum/rarefied gas based energy conversion devices which rely on nuclear radiation to produce electrical power.

### BACKGROUND

The invention described herein converts energy released by nuclear events in a nuclear source to useful electrical work via thermoelectron emission using a design that minimizes energy loss through direct thermal transport and energy loss as a result of thermal photon emission. To understand this invention, the details of the various processes of energy transfer will be discussed, starting at the nuclear source and ending with electrical work performed external to the invention. Specific means of achieving design objectives will be described as necessary. Generally speaking, energy is released in a nuclear source due to nuclear events and travels to an emitter electrode in the form of kinetic energy of particles of nuclear radiation. The energy of the nuclear radiation is absorbed by the emitter electrode, and eventually exits the electrode in various forms to be discussed. The emitter electrode and its configuration within the invention are designed such that the majority of the energy exits the emitter electrode carried by thermoelectrons, while other energy transport mechanisms such as direct thermal transport and thermal photon emission are minimized. Therefore, the majority of the energy released by nuclear events in the nuclear source is converted to energy carried by thermoelectrons which can be used to do useful electrical work in an electrical load external to the disclosed invention.

There exist a number of nuclear processes by which the nucleus of an atom is changed and energy is released. The general process of an atomic nucleus changing and releasing energy will be referred to as a “nuclear event.” Such nuclear processes include nuclear decay in which an unstable atomic nucleus suddenly breaks apart into smaller nuclei. Nuclear fission is another such process in which a larger nucleus is stimulated and splits into two smaller nuclei. Nuclear fusion is the third such process in which smaller nuclei combine into a larger nucleus.

Energy released by a nuclear event takes the form of kinetic energy of a particle or particles ejected as a result of the nuclear event. These particles are referred to as “nuclear radiation.” Nuclear radiation can be in the form of α, β, γ, neutron, or other energetic particles depending on the reaction. Typically, if a flux of nuclear radiation (particles of nuclear radiation per unit area per unit time) is incident on a body, the majority of the energy carried by the radiation will be transferred to the body by a series of interactions of the particle with the atoms comprising the body. The details of these interactions are numerous and beyond the scope of this discussion, but ultimately energy transferred in this way manifests in the form of heat in the body. On average, particles of nuclear radiation will penetrate a particular distance into a material depending on several factors including the type of particle, its initial energy, and the material of the body; this distance is called the “penetration depth.” In the case of a radioisotope experiencing nuclear decay, nuclear radiation resulting from nuclear events in the bulk of the material can be blocked by the radioisotope material itself. This phenomenon is known as “self-shielding.” The dimensions of a radioisotope nuclear source can be chosen to maximize the energy flux of nuclear radiation (energy per unit area per unit time) vs. the specific activity of the material (number of events per unit mass per unit time).

The classical law of conservation of energy states that energy can neither be created nor destroyed, it can only change from one form to another. The amount of internal energy of a body otherwise isolated from its environment can therefore only be increased if some external source adds energy to the body, and can only decrease if energy exits the body. The absolute temperature of a body (measured in Kelvin) is a measure of the internal energy of the body; ignoring phase changes, a body at a higher temperature has greater internal energy than the same body at a lower temperature. Put another way, energy added to a body at a particular temperature will result in the increase of that body's temperature. In the case of nuclear radiation incident on a body, the temperature of the body will increase until the energy entering the body via nuclear radiation is balanced by energy leaving the body.

There are several temperature-dependent processes by which energy exits a body at a particular temperature. One such process is direct thermal conduction, also referred to as thermal transport. Consider a metallic electrode suspended by a wire inside a container which is evacuated of gas. Let the container be a “thermal reservoir”, that is to say the container is sufficiently massive that energy added to or taken from the container in the form of heat causes a negligible change in the temperature of the container. If the temperature of the electrode is higher than the container, heat will travel from the electrode into the walls of the container via the suspension wire.

The geometry of the suspension wire and material(s) from which the wire is made have a large effect on the heat transfer rate between the two bodies. Generally speaking, the length of the suspension wire is inversely proportional to the heat transfer rate; i.e. a longer wire results in a lower rate of heat transfer. Furthermore, the cross-sectional area of the suspension wire is proportional to the heat transfer rate; i.e. a thicker wire results in a higher rate of heat transfer. The number of physical connections between the container and the electrode are proportional to the heat transfer rate; i.e. more connections result in a higher rate of heat transfer. Finally, the material from which the suspension rod is made has an effect on the heat transfer rate. For example, insulating oxides such as silicon dioxide are relatively poor conductors of heat, whereas metals such as OFHC copper are relatively good conductors of heat. These rules are generally true regardless of any other functionality of the physical connection between the electrode and container. For example, heat will be conducted through an electrical connection between the electrode and container as well as through any mechanical components used for positioning or stabilizing the electrode.

For the disclosed invention, energy transfer from the electrode via direct thermal transport is parasitic and detracts from the intended operation of the device. Using techniques of MEMS engineering, electrical and mechanical connections between the electrode and its container can be fabricated to minimize parasitic direct thermal transport. Lee et. al. [1] demonstrate one such approach.

A second process by which energy exits a body is thermal photon emission. In general, a material at a finite temperature emits photons in a process known as blackbody radiation. Photons at all energies are emitted from a body at a finite temperature according to Planck's distribution, and this distribution exhibits a peak given by Wien's displacement law. As the temperature of the body increases, the energy at which the peak of the distribution occurs increases, as does the number of photons emitted.

Like direct thermal transport, energy transport from the emitter via thermal photon radiation is parasitic for the intended operation of the disclosed invention. Many techniques in the field of photonic engineering exist to alter the emission spectrum of thermal photons; for example, two- and three-dimensional photonic crystals, thin film resonances, and metamaterial patterning of surfaces [2,3]. Such approaches are used in the case of the emitter electrode of the disclosed invention to suppress parts of the thermal photon emission spectrum to minimize parasitic energy loss via thermal photons.

Thermoelectron emission is the emission of electrons from a solid material held at an elevated temperature. The term “thermoelectron” is preferred here over the more commonly used “thermionic” to highlight the fact that electrons, not ions, are involved in the operation of such devices. The increased temperature increases the population of electrons at higher energy states within the material. Electrons with sufficiently high energy near the surface of the material escape as the thermoelectron current. The magnitude of the thermoelectron emission current is determined by the temperature of the material and the material's physical properties, particularly the energy barrier which electrons encounter at the surface of the material, commonly known as the “work function.”

Energy exits the electrode carried by the thermoelectron current. In contrast to direct thermal transport or thermal photon emission, thermoelectron emission is the preferred phenomenon of energy transport from the electrode because the thermoelectron current is converted to useful electrical work in an electrical load external to the disclosed invention. Therefore, the emitter geometry, material(s), and configuration are chosen and engineered to minimize parasitic energy loss via direct thermal transport and thermal photon emission, and to maximize thermoelectron emission.

Vacuum and rarefied gas based electronic devices are devices in which two or more electrodes are enclosed in a container. In the case of a vacuum device, the enclosed volume is evacuated of atmosphere to an acceptably low pressure for the desired application. In the case of a rarefied gas based device, the enclosure is first evacuated to an acceptably low pressure, and then the volume is backfilled with a particular gas or mixture of gases to a particular pressure; the composition and pressure of gases are chosen for the desired application of the device. Many types of electronic devices can be created in this way, and the desired behavior of the device can be achieved by manipulating any of the following or a combination thereof: electric or magnetic fields within the device, the level of vacuum within the device, the composition of gas within the device, or the physical properties, geometries, and arrangement of electrodes within the device.

One such device is known as a “thermoelectron engine,” sometimes referred to as a “thermoelectron energy converter” and abbreviated as TEC. The TEC is comprised of at least two electrodes. Stimulus in the form of heat is added to one of the electrodes, known as the “emitter” or “cathode.” This stimulus results in a current of electrons escaping the emitter via the phenomenon of thermoelectron emission. A second electrode known as the “collector” or “anode” is located nearby the emitter and is configured such that heat is removed from the collector. The electron current escaping the emitter is absorbed by the collector. If an external electrical load is wired to the emitter and collector electrodes, the current traveling from the emitter electrode to the collector electrode within the TEC will be driven through the external load. In this way the TEC converts the heat stimulating the emitter electrode into electricity.

If the enclosure is evacuated of atmosphere, the device is known as a “vacuum TEC.” The enclosure may be backfilled with a gas or mixture of gases to achieve some desired effect such as improving some aspect of device performance; in this case the device is known as a “vapor TEC.” Electrodes other than the emitter and collector may be present within the device to provide an electric field within the device, and magnetic fields may also be applied within the device in order to improve some aspect of performance of the device.

### BIBLIOGRAPHY

[1] Jae Hyung Lee, I. Bargatin, T. O. Gwinn, M. Vincent, K. A. Littau, Roya Maboudian, Z. X Shen, Nicholas A. Melosh, and R. T. Howe. Microfabricated silicon carbide thermionic energy converter for solar electricity generation. In Micro Electro Mechanical Systems (MEMS), 2012 IEEE 25th International Conference on, pages 1261-1264, 2012.
[2] Veronika Rinnerbauer, Sidy Ndao, Yi Xiang Yeng, Walker R. Chan, Jay J. Senkevich, John D. Joannopoulos, Marin Soljacic, and Ivan Celanovic. Recent developments in high-temperature photonic crystals for energy conversion. Energy Environ. Sci., 5:8815-8823, 2012.
[3] P. N. Dyachenko, S. Molesky, A. Yu Petrov, M. Stormer, T. Krekeler, S. Lang, M. Ritter, Z. Jacob, and M. Eich. Controlling thermal emission with refractory epsilon-near-zero metamaterials via topological transitions. Nature Communications, 7:11809, 2016.

### SUMMARY

Certain embodiments of the disclosed subject matter include a thermoelectron energy converter (TEC). The TEC can include an emitter electrode and a collector electrode enclosed in a container. The emitter electrode and collector electrode are separated from one another by a distance. The container may be evacuated, partially evacuated, or contain some atmosphere of gas or a mixture of gases. The emitter electrode can be in electrical contact with a lead or wire which penetrates the container and terminates at an electrical terminal outside the container. The emitter electrode can be positioned and stabilized by mechanical components connecting it to other parts of the TEC, for example, the container. The collector electrode can be in electrical contact with a lead or wire which penetrates the container and terminates at an electrical terminal outside the container.

In any of the embodiments described herein, the emitter electrode can be in the vicinity of a nuclear source emitting nuclear radiation in the form of one or a combination of α, β, γ, neutron, or other radiation.

In any of the embodiments described herein, energy can be transferred from the nuclear events located within the nuclear source to the emitter electrode via the particles of nuclear radiation such as one or a combination of α, β, γ, neutron, or other radiation, resulting in an increase in temperature of the emitter electrode above the emitter electrode's ambient temperature.

In any of the embodiments described herein, the emitter electrode can be in electrical contact with an electrical lead or wire. The electrical lead can be connected to an electrical circuit external to the emitter electrode, or the electrical lead can be connected to ground. Electrons emitted from the emitter electrode can be replenished by a current of electrons entering the emitter electrode through the electrical lead.

In any of the embodiments described herein, an external electrical circuit can be connected between the two external cathode and anode terminals of the TEC. Current emanating from the emitter electrode and absorbed at the collector electrode can be driven through the external electrical circuit.

In any of the embodiments described herein, the material and configuration of the mechanical components used for stabilizing and positioning the emitter electrode within the TEC, as well as the material and configuration of the electrical lead connecting the emitter electrode to the electrical terminal on the exterior of the TEC, can be chosen or engineered to minimize the energy leaving the emitter electrode to the ambient environment in the form of heat by the process of direct thermal conduction through solid mechanical and electrical components.

In any of the embodiments described herein, the materials comprising the emitter electrode can be chosen or engineered to minimize the energy leaving the emitter electrode to the ambient environment or other components of the TEC in the form of thermal photon emission by suppressing part or all of the thermal photon energy spectrum.

In any of the embodiments described herein, the structure of the emitter electrode, both internally and at the surface of the emitter electrode, can be engineered and fabricated to minimize the energy leaving the emitter electrode to the ambient environment or other components of the TEC in the form of thermal photon emission by suppressing part or all of the thermal photon energy spectrum.

In any of the embodiments described herein, energy transferred from nuclear events within the nuclear source to the emitter electrode via nuclear radiation, and resulting in an increase in temperature of the emitter electrode above the emitter electrode's ambient temperature can generate a thermoelectron current emanating from the emitter electrode. The electron current emanating from the emitter electrode can travel to the collector electrode where it is absorbed.

In any of the embodiments described herein, the source of nuclear radiation can be a fission reaction, a fusion reaction, or a radioisotope experiencing nuclear decay.

In any of the embodiments described herein, if the source of nuclear radiation is a radioisotope experiencing nuclear decay, the dimensions of the radioisotope material can be chosen to minimize self-shielding of the nuclear radiation by the radioisotope itself and therefore maximize the energy flux (energy per unit area per unit time) of the nuclear radiation per specific nuclear activity (number of nuclear decay events per unit mass per unit time) of the radioisotope nuclear source.

In any of the embodiments described herein, if the source of nuclear radiation is a radioisotope experiencing nuclear decay, a “cell” comprising the radioisotope, the emitter electrode, and the collector electrode can be configured in a repeating fashion.

### BRIEF DESCRIPTION OF THE DRAWINGS

For a more complete understanding of the invention, reference is made to the following description and accompanying drawings, in which:

FIG. 1 depicts an emitter structure in proximity to a nuclear source and the processes by which energy enters and exits the emitter structure, namely, the nuclear radiation of the source, the direct thermal conduction through mechanical and electrical supporting components of the emitter, thermal photon radiation from the emitter, and thermoelectron emission from the emitter;

FIG. 2 depicts the general configuration of the components comprising a TEC claimed in this disclosure; and

FIG. 3 depicts a repeating cell configuration of a TEC.

### DETAILED DESCRIPTION

Reference now will be made in detail to embodiments of the disclosed subject matter. Such embodiments are provided by way of explanation of the disclosed subject matter, and the embodiments are not intended to be limiting. In fact, those of ordinary skill in the art can appreciate upon reading the specification and viewing the drawings that various modifications and variations can be made.

Before explaining at least one embodiment of the disclosed subject matter in detail, it is to be understood that the disclosed subject matter is not limited in its application to the details of construction and to arrangements of the components set forth in the following description or illustrated in the drawings. The disclosed subject matter can be manifested in other embodiments and of being practiced and carried out in various ways. Also, it is to be understood that the phraseology and terminology employed herein are for the purpose of description and should not be regarded as limiting. Numerous embodiments are described in this patent application, and are presented for illustrative purposes only. The described embodiments are not intended to be limiting in any sense. The disclosed subject matter is widely applicable to numerous embodiments, as is readily apparent from the disclosure herein. Those skilled in the art will recognize that the disclosed subject matter can be practiced with various modifications and alterations. Although particular features of the disclosed subject matter can be described with reference to one or more particular embodiments or figures, it should be understood that such features are not limited to usage in the one or more particular embodiments or figures with reference to which they are described.

As such, those skilled in the art will appreciate that the conception, upon which this disclosure is based, can readily be utilized as a basis for the designing of other structures, methods and systems for carrying out the several purposes of the disclosed subject matter. It is important, therefore, that the disclosed subject matter be regarded as including equivalent constructions to those described herein insofar as they do not depart from the spirit and scope of the disclosed subject matter.

In addition, features illustrated or described as part of one embodiment can be used on other embodiments to yield a still further embodiment. Additionally, certain features can be interchanged with similar devices or features not mentioned yet which perform the same or similar functions. It is therefore intended that such modifications and variations are included within the totality of the disclosed subject matter.

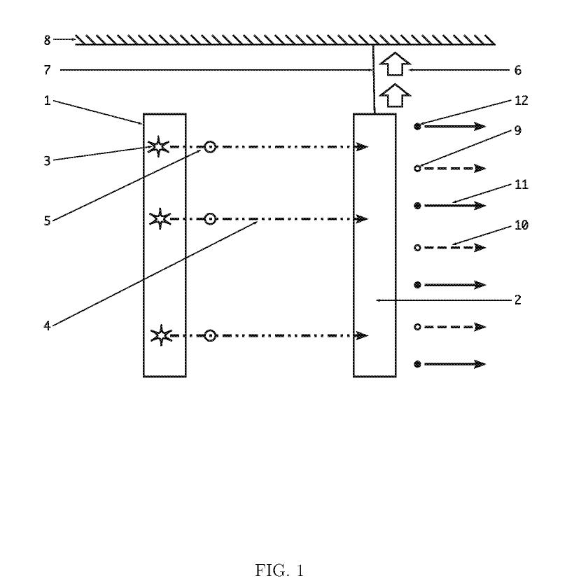

Reference is now made to FIG. 1. FIG. 1 depicts the key mechanisms by which energy is transferred from the nuclear source [1] to the emitter electrode [2] and beyond. nuclear events [3] within the nuclear source [1] occur and emit a nuclear radiation flux [4] comprising nuclear radiation particles [5] such as one or a combination of α, β, γ, neutron, or other radiation. This nuclear radiation flux [4] carries energy and is incident on the emitter electrode [2] where it is absorbed and manifest chiefly as heat in the emitter electrode [2]. This heat results in an increase in the temperature of the emitter electrode [2] above the ambient temperature of the emitter electrode [2]. Energy leaves the emitter electrode [2] via direct thermal transport [6] through one or more mechanical connections [7] to the ambient environment [8]. Any direct mechanical connections [7], even, for example, those serving the purpose of an electrical conductor, result in parasitic heat loss from the emitter electrode [2] via direct thermal transport [6]. Energy also exits the emitter electrode [2] via thermal photons [9] comprising a flux of thermal photon emission [10] which is a parasitic energy loss. A thermoelectron current [11] of thermoelectrons [12] emanates from the emitter electrode [2] as a result of the elevated temperature of the emitter electrode [2] above the ambient temperature of the emitter electrode [2].

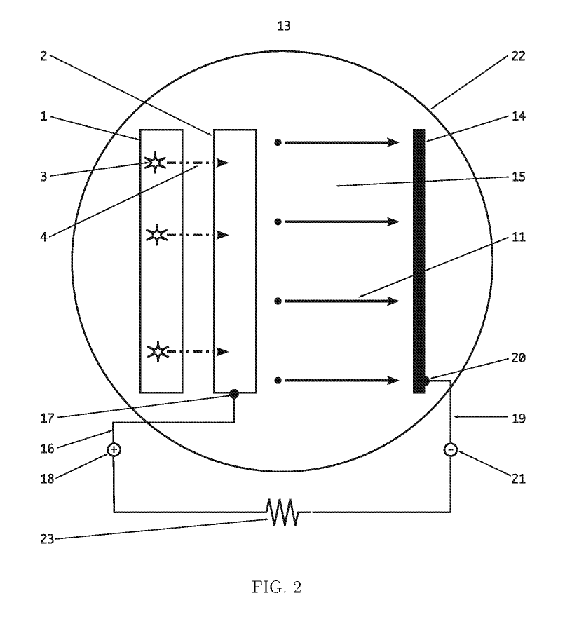

Reference is now made to FIG. 2. FIG. 2 depicts a TEC [13] comprising an emitter electrode [2], a collector electrode [14] separated from the emitter electrode [2] by an interelectrode gap [15], a nuclear source [1] in the vicinity of the emitter electrode [2], an emitter lead [16] in electrical contact [17] to the emitter electrode [2] which penetrates the enclosure [22] and terminates outside the enclosure [22] at a positive electrical terminal [18], a collector lead [19] in electrical contact [20] to the collector electrode [14] which penetrates the enclosure [22] and terminates outside the enclosure [22] at a negative electrical terminal [21], and an enclosure [22] surrounding the emitter electrode [2], the collector electrode [14], and the nuclear source [1]. The enclosure [22] may be evacuated, partially evacuated, or contain some atmosphere of a gas or mixture of gases. The nuclear source [1] experiences nuclear events [3] resulting in emission of a nuclear radiation flux [4] comprising one or a combination of α, β, γ, neutron, or other radiation. The nuclear radiation flux [4] strikes the emitter electrode [2], transferring its energy to the emitter electrode [2] and raising the temperature of the emitter electrode [2]. A thermoelectron current [11] emanates from the emitter electrode [2] as a result of the increased temperature. The thermoelectron current [11] traverses the interelectrode gap [15] and arrives at the collector electrode [14] where it is absorbed. The electrical current will travel through an external electrical load [23] connected between the positive electrical terminal [18] and negative electrical terminal [21] and perform electrical work.

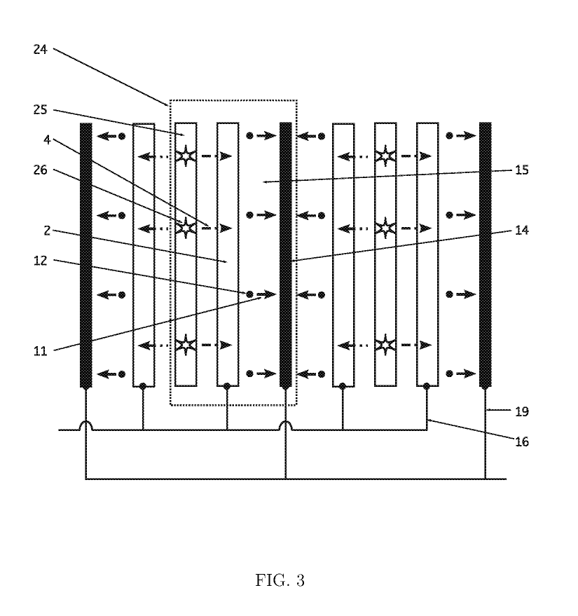

Reference is now made to FIG. 3. FIG. 3 depicts the internal components and general configuration of a repeated cellular configuration of the invention. FIG. 3 depicts a cell [24] comprising a radioisotope nuclear source [25], an emitter electrode [2], and a collector electrode [14]. Cells are arranged in a repeating fashion (linearly repeating shown). The cellular components of radioisotope nuclear source [25], emitter electrode [2], and collector electrode [14] may be shared by one or more cell [24] as the application of the device dictates. nuclear decay events [26] within a radioisotope nuclear source [25] emits nuclear radiation flux [4] in the form of one or a combination of α, β, γ, neutron, or other radiation. The nuclear radiation flux [4] is incident on a proximate emitter electrode [2], thereby transferring the energy of the nuclear radiation flux [4] to the proximate emitter electrode [2] in the form of heat and resulting in an increase of the temperature of the emitter electrode [2] above the ambient temperature of the emitter electrode [2]. As a result of the elevated temperature of an emitter electrode [2], thermoelectrons [12] are emitted as a thermoelectron current [11] from the emitter electrode [2] and traverse an interelectrode gap [15] to a proximate collector electrode [14]. Collector electrodes from different cells can share the collector lead [19] in parallel (shown), series, or a combination as the application of the device dictates. Emitter electrodes from different cells can share the emitter lead [16] in parallel (shown), series, or a combination as the application of the device dictates.

Having thus described several aspects of at least one embodiment of this disclosed subject matter, it is to be appreciated various alterations, modifications, and improvements will readily occur to those skilled in the art. Such alterations, modifications, and improvements are intended to be part of this disclosure, and are intended to be within the spirit and scope of the disclosed subject matter. Accordingly, the foregoing description and drawings are by way of example only.

What is claimed:

1. A thermoelectron energy converter (TEC) comprising:
an emitter electrode
a collector electrode
an enclosure surrounding the emitter electrode and collector electrode
The mechanical components required to position and stabilize the emitter and collector within the container
an electrical lead making electrical contact with the emitter electrode, penetrating the enclosure and terminating at an electrical terminal outside the enclosure
an electrical lead making electrical contact with the collector electrode, penetrating the enclosure and terminating at an electrical terminal outside the enclosure
one or more sources of nuclear radiation in the vicinity of the emitter electrode.

2. The TEC from claim 1 in which the nuclear source emits nuclear radiation in the form of one or a combination of α, β, γ, neutron, or other radiation.

3. The TEC from claim 2 in which the nuclear radiation is incident on the emitter electrode and thereby transfers energy from the nuclear events of the nuclear source to the emitter electrode.

4. The TEC from claim 3 in which both the electrical leads connecting the emitter electrode to an external electrical circuit and the mechanical components connecting the emitter electrode to the container for the purposes of positioning and stabilization are chosen, designed, and engineered to minimize direct thermal transport of energy from the emitter electrode to the ambient environment.

5. The TEC from claim 4 in which the emitter material and structure is chosen, designed, and engineered using techniques in the field of photonic engineering such as two- and three-dimensional photonic crystals, thin film resonances, metamaterial patterning, and etc. to minimize the energy flux (energy carried by thermal photon radiation per unit area per unit time) from the emitter structure in the form of thermal photon emission.

6. The TEC from claim 5 in which the source of nuclear radiation is a fission reaction or a fusion reaction.

7. The TEC from claim 5 in which the source of nuclear radiation is a radioisotope experiencing nuclear decay.

8. The TEC from claim 7 in which the dimensions of the radioisotope are chosen to minimize self-absorption of nuclear radiation and to maximize the energy flux (energy carried by nuclear radiation per unit area per unit time) of nuclear radiation per the specific activity (number of events per unit mass per unit time) of the nuclear source.

9. The TEC of claim 8 in which the emitter electrode material and its dimensions are optimized such that all, or a majority of, the energy of the incident nuclear radiation is absorbed by the emitter electrode.

10. The TEC of claim 9 in which repeating cells of radioisotope source, emitter electrode, and collector electrode are arranged in a repeating fashion to optimize the conversion of energy released by nuclear decay to useful electrical work delivered to the external electrical load.

11. The TEC of claim 7, claim 9, or claim 10 in which the temperature of the emitter may be pre-set to its equilibrium temperature via any number of mechanisms including, but not limited to, resistive heating using the emitter's electrical lead(s), electron-beam heating, radiative heating via a blackbody filament or laser, or placing the entire assembly in a furnace to mitigate the case in which radiation from the source may be relatively low and require an unacceptably long time before sufficient energy has been added to the emitter to reach equilibrium temperature.
